(19) United States
(12) Patent Application Publication
(10) Pub. No.: US 2015/0229045 A1
(43) Pub. Date: Aug. 13, 2015

(54) CONNECTION MODULE

(71) Applicant: PHOENIX CONTACT GMBH & CO.KG, Blomberg (DE)

(72) Inventor: Detlev Falk, Blomberg (DE)

(21) Appl. No.: 14/419,656

(22) PCT Filed: Jul. 16, 2013
(86) PCT No.: PCT/EP2013/064998

§ 371 Date: Feb. 5, 2015

(30) Foreign Application Priority Data
Aug. 8, 2012 (DE) 10 2012 107 264.7

(51) Int. Cl. H01R 9/26

(52) U.S. Cl. CPC H01R 9/26

(57) ABSTRACT

A connection module includes a housing having a housing base and a housing upper surface. The housing is configured to fix to a mounting rail via the housing base via a pivoting movement of the housing. The connection module includes a plurality of connection elements arranged in the housing, and at least one jumper insertion opening for receiving a jumper. The jumper is disposed in a transverse side of the housing. The connection module includes a contact element for forming an electrical contact with the jumper. The contact element is arranged in the jumper insertion opening. The jumper insertion opening extends in the direction of insertion of the jumper into the jumper insertion opening from the housing base towards the housing upper surface at an angle α of between 20 and 70 degrees to a transverse axis of the housing.

### CROSS-REFERENCE TO RELATED APPLICATIONS

This application is a U.S. National Phase application under 35 U.S.C. §371 of International Application No. PCT/EP2013/064998, filed on Jul. 16, 2013, and claims benefit to German Patent Application No. DE 10 2012 107 264.7, filed on Aug. 8, 2012. The International Application was published in German on Feb. 13, 2014, as WO 2014/023532 A1 under PCT Article 21 (2).

### FIELD

The invention relates to a connection module, comprising a housing having a housing base and a housing upper surface, the housing being capable of being fixed to a mounting rail via the housing base by means of a pivoting movement of the housing, a plurality of connection elements which are arranged in the housing, and at least one jumper insertion opening, for receiving a jumper, which is arranged in a transverse side of the housing, a contact element, for forming an electrical contact with the jumper, being arranged in the jumper insertion opening.

### BACKGROUND

A connection module of this type is usually disc shaped, it being possible for a plurality of connection modules to be arranged in series on a mounting rail in order to form a connection module unit. Jumpers or bus systems can be used to interconnect the individual connection modules.

A bus system is usually fixed to the mounting rail in such a way that the housing of the connection module is connected to the mounting rail and the bus system via the housing base. A drawback of mounting rail bus systems of this type is the low current-carrying capacity, which is at most 8 A, making it insufficient for some applications.

When using bus systems in the form of jumpers that each extend over a plurality of connection modules which are arranged in series, it is known, for example from WO 2011/107457 A1, to fix said connection modules to a transverse side of the housing rather than to the housing base. When assembling a connection module unit of this type, the individual connection modules are firstly snapped onto the mounting rail, and then one or more jumpers are snapped into the connection modules on the mounting rail. To disassemble the connection module unit, the jumpers have to be removed first, before individual connection modules can be detached from the mounting rail, thereby leading to laborious and time-consuming handling.

### SUMMARY

In an embodiment, the present invention provides a connection module comprising a housing having a housing base and a housing upper surface. The housing is configured to fix to a mounting rail via the housing base via a pivoting movement of the housing. The connection module includes a plurality of connection elements disposed in the housing, and at least one jumper insertion opening for receiving a jumper. The at least one jumper insertion opening is disposed in a transverse side of the housing. The connection module includes a contact element for forming an electrical contact with the jumper. The contact element is disposed in the jumper insertion opening. The jumper insertion opening extends in the direction of insertion of the jumper into the jumper insertion opening from the housing base towards the housing upper surface at an angle α of between 20 and 70 degrees to a transverse axis of the housing.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows three connection modules arranged side by side on a mounting rail in accordance with the present invention.

### DETAILED DESCRIPTION

An aspect of the invention provides a connection module in which the handling when fixing the connection module to a mounting rail and to a jumper, and when detaching the connection module from a mounting rail and from a jumper, is improved.

In a connection module of the type described in greater detail at the outset, aspect in an embodiment of the invention the jumper insertion opening extends in the direction of insertion of the jumper into the jumper insertion opening from the housing base towards the housing upper surface at an angle α of between 20 and 70° to the transverse axis of the housing.

According to an embodiment of the invention, the jumper insertion opening extends, from the start to the end thereof, where the jumper rests when inserted, from the bottom up, i.e. from the housing base towards the housing upper surface, in such a way that the jumper insertion opening is oriented at an angle to the transverse axis of the housing. In this arrangement, the angle α of the jumper insertion opening to the transverse axis of the housing is between 20 and 70°, preferably between 30 and 60° and more preferably 45°. The angle α is dependent on the pivoting movement of the housing of the connection module on the mounting rail and on the position of the jumper relative to the housing. When the connection module pivots laterally on the mounting rail, this angle α makes it possible for the jumper insertion opening of the connection module to be connected to the jumper arranged to the side of the mounting rail by inserting the jumper into the jumper insertion opening, and to be disconnected again. A connection module which is arranged centrally between two connection modules can thus be disconnected from the mounting rail and from the jumper without the connection modules which are arranged adjacent thereto also having to be detached from the mounting rail. It is also thus possible to fix a connection module between two connection modules which are already arranged on the mounting rail without detaching the adjacent connection modules, by pivoting the connection module to be fixed to the mounting rail and by hooking or latching the connection module onto both the mounting rail and the jumper. The jumper is preferably in the form of an elongate rail, the length of said rail being able to be adapted to the number of connection modules which are arranged in series and combined to form a unit. In this case, a connection module unit comprises a plurality of connection modules, at least one jumper and a mounting rail. The simplified process of fixing and replacing a connection module in a connection module unit brought about by the connection module according to the invention makes it substantially easier and thus quicker for the user to handle a connection module and thus a connection module unit.

According to a preferred embodiment of the invention, the jumper insertion opening is arranged in an upper region of the transverse side of the housing, which region is arranged so as to be adjacent to the housing upper surface. This makes it possible for the jumper insertion opening to be positioned particularly advantageously relative to the centre of rotation of the connection module on the mounting rail, to make it as easy as possible for the connection module to be disconnected and fixed via the jumper insertion opening to a jumper which is in a fixed position.

The jumper insertion opening is preferably formed in a module insert, the module insert being inserted into an opening which is formed in the transverse side of the housing. The module insert is formed as a separate component to the housing of the connection module and to the two housing halves, which are assembled to form the housing of the connection module, and said insert can therefore be separated from the housing and the two housing halves. When the connection module is being assembled and before the two housing halves are assembled to form a housing, the module insert is inserted into a first recess formed in a first housing half, said recess forming, together with a second recess formed in a second housing half, the opening in the transverse side of the housing when the two housing halves are assembled. The module insert comprises one or more jumper insertion openings as well as the contact elements which are arranged in the jumper insertion openings. When inserted, the module insert is preferably flush with the transverse side of the housing. Since the module insert is easy to replace, a suitable module insert, which has a number of jumper insertion openings which is adapted to the number of jumpers, can be selected according to the number of jumpers. If, moreover, the contact element which is arranged in the jumper insertion opening is no longer operational, the module insert can be replaced quickly, easily and cost-effectively without the entire connection module having to be replaced. The module insert can be detachably fixed, for example by means of a snap-on connection, in the opening in the transverse side of the housing or in the recesses in the two housing halves forming the opening. As an alternative to the module insert, it is, however, also possible to form the jumper insertion opening directly in the transverse side of the housing so that it is part of the housing or the housing halves.

Furthermore, it is preferably provided that the jumper insertion opening is arranged in a retaining element protruding from the transverse side of the housing, said element preferably being U-shaped. The protrusion of the retaining element from the transverse side of the housing prevents the jumper insertion opening from taking up any of the installation space inside the housing. The preferably U-shaped retaining element has two retaining arms which are arranged parallel to each other, between which the jumper insertion opening is formed in such a way that a jumper inserted into the jumper insertion opening is retained between the two retaining arms. The contact element, which is preferably also U-shaped, is also arranged between these two retaining arms in such a way that it rests directly on the retaining arms and can thus be retained by the retaining arms. The retaining element can either be formed on a module insert or can be formed directly on the transverse side of the housing, in which case it is formed integrally with the housing.

The invention is described in greater detail below on the basis of a preferred embodiment with reference to the accompanying drawing.

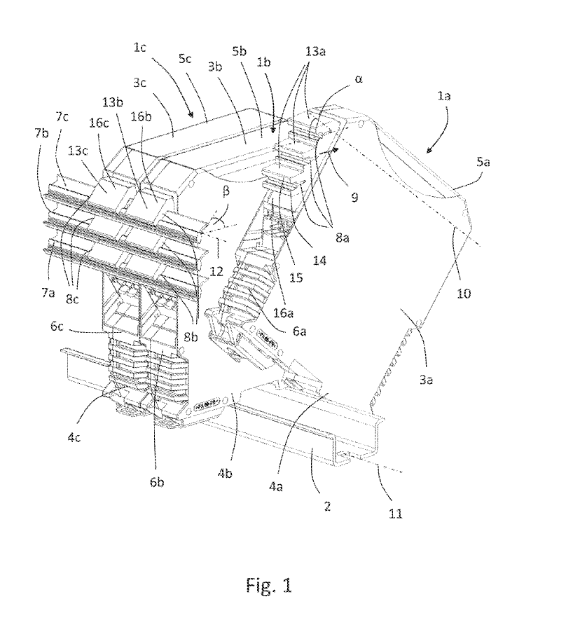

FIG. 1 shows three connection modules 1a, 1b, 1c which are arranged side by side, two of the connection modules 1b, 1c being fixed to a mounting rail 2 and the third connection module 1a being shown in a position in which it is being pivoted on the mounting rail 2 so that it can be disconnected or fixed. The connection modules 1a, 1b, 1c are disc shaped and have a substantially rectangular housing 3a, 3b, 3c. The housings 3a, 3b, 3c are each formed of two housing halves. A plurality of connection elements are arranged inside the housing 3a, 3b, 3c. The housings 3a, 3b, 3c each have a housing base 4a, 4b, 4c and a housing upper surface 5a, 5b, 5c which is formed opposite the housing base 4a, 4b, 4c, the housing 3a, 3b, 3c being capable of being fixed to the mounting rail 2 by means of the housing base 4a, 4b, 4c.

On a transverse side 6a, 6b, 6c of the housing 3a, 3b, 3c extending between the housing base 4a, 4b, 4c and the housing upper surface 5a, 5b, 5c, the connection modules 1a, 1b, 1c are connected to three jumpers 7a, 7b, 7c, respectively, which are fixed in position relative to the mounting rail 2. The connection is produced by means of jumper insertion openings 8a, 8b, 8c which are formed in the transverse side 6a, 6b, 6c of the housing 3a, 3b, 3c, the connection modules 1a, 1b, 1c in this case having three jumper insertion openings 8a, 8b, 8c, respectively, which are arranged one on top of the other. A contact element for forming an electrical contact with the jumper 7a, 7b, 7c is arranged inside each jumper insertion opening 8a, 8b, 8c. The contact elements are connected to the connection elements which are arranged in the housing 3a, 3b, 3c, more particularly to the bus bars which are arranged in the connection elements. The contact elements are preferably in the form of U-shaped contact terminals, which the jumpers 7a, 7b, 7c can encompass on one of the edges thereof to form an electrical contact.

The jumpers 7a, 7b, 7c are each in the form of a rail, more particularly a copper rail, and are used to supply current to the connection modules, more particularly to the bus bars inside the connection modules, it being possible in this case to transmit a current of up to 40 A. The length of the jumpers 7a, 7b, 7c can be adapted by reducing the number of connection modules 1a, 1b, 1c to be bridged. The jumpers 7a, 7b, 7c are each oriented with the longitudinal axis thereof running parallel to the longitudinal axis of the mounting rail 2 and are laterally offset with respect to the mounting rail 2 and arranged above the mounting rail 2.

The jumpers 7a, 7b, 7c, which instead of being arranged in a straight line to the longitudinal axis 11 of the mounting rail 2 are arranged at a tilt to the longitudinal axis 11 of the mounting rail 2 with an angle of inclination β>0° with respect to their own longitudinal axis 12, are inserted into the corresponding jumper insertion openings 8a, 8b, 8c in the connection modules 1a, 1b, 1c by a pivoting movement of the connection modules 1a, 1b, 1c on the mounting rail 2 towards the jumpers 7a, 7b, 7c, in order to form a contact with the connection modules 1a, 1b, 1c. In doing so, the jumper insertion openings 8a, 8b, 8c extend in the direction of insertion (indicated by the arrow 9) of the jumpers 7a, 7b, 7c into the jumper insertion openings 8a, 8b, 8c from the housing base 4a, 4b, 4c towards the housing upper surface 5a, 5b, 5c at an angle α of between 20 and 70°, preferably of 45°, to the transverse axis 10 of the housing 3a, 3b, 3c, shown here by the first connection module 1a. The angle α of the jumper insertion opening 8a, 8b, 8c is, in this case, adapted to the angle of inclination β of the jumper 7a, 7b, 7c, the angle α preferably corresponding to the angle of inclination β, in order to make it possible for the jumpers 7a, 7b, 7c to be inserted easily and uniformly into the respective jumper insertion openings 8a, 8b, 8c when the housing 3a, 3b, 3c of the connection module 1a, 1b, 1c is pivoted on the mounting rail 2.

Here, the jumper insertion openings 8a, 8b, 8c are arranged in an upper region of the transverse side 6a, 6b, 6c of the housing 3a, 3b, 3c which is arranged so as to be adjacent to the housing upper surface 5a, 5c, 5d.

In the embodiment shown here, the jumper insertion openings 8a, 8b, 8c are formed in U-shaped retaining elements 13a, 13b, 13c, which are formed on the transverse side 6a, 6b, 6c of the housing 3a, 3b, 3c and protrude therefrom, as a result of being pointed away from the housing 3a, 3b, 3c. The jumper insertion openings 8a, 8b, 8c thus do not extend into the housing halves of the housing 3a, 3b, 3c.

The U-shaped retaining elements 13a, 13b, 13c each comprise two retaining arms 14, 15 which are arranged parallel to each other, between which a jumper insertion opening 8a, 8b, 8c is formed in each case, in such a way that a jumper 7a, 7b, 7c which is inserted into the jumper insertion opening 8a, 8b, 8c is retained between the two retaining arms 14, 15. The contact element, which is preferably also U-shaped so that it can rest directly on the retaining arms 14, 15 and, in doing so, can be retained by the retaining arms 14, 15, is also arranged between these two retaining arms 14, 15.

In the embodiment shown here, each connection module 1a, 1b, 1c comprises three retaining elements 13a, 13b, 13c, the retaining elements 13a, 13b, 13c and, as a result, the jumper insertion openings 8a, 8b, 8c being formed on/in a substantially plate-shaped module insert 16a, 16b, 16c. The module inserts 16a, 16b, 16c are each inserted into an opening formed in the transverse side 6a, 6b, 6c of the housing 3a, 3b, 3c, the module inserts 16a, 16b, 16c being inserted before the two housing halves of the housing 3a, 3b, 3c are assembled.

Both the housing 3a, 3b, 3c as well as the retaining elements 13a, 13b, 13c and the module insert 16a, 16b, 16c are preferably made of an insulating material, such as a plastics material.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Connection module 1a, 1b, 1c
Mounting rail 2
Housing 3a, 3b, 3c
Housing base 4a, 4b, 4c
Housing upper surface 5a, 5b, 5c
Transverse side 6a, 6b, 6c
Jumper 7a, 7b, 7c
Jumper insertion opening 8a, 8b, 8c
Direction of insertion 9
Transverse axis 10
Longitudinal axis 11
Longitudinal axis 12
Retaining element 13a, 13b, 13c
Retaining arm 14
Retaining arm 15
Module insert 16a, 16b, 16c

1. A connection module, comprising:
a housing having a housing base and a housing upper surface, the housing being configured to fix to a mounting rail via the housing base via a pivoting movement of the housing;
a plurality of connection elements disposed in the housing
at least one jumper insertion opening for receiving a jumper the at least one jumper insertion opening being disposed in a transverse side of the housing; and
a contact element for forming an electrical contact with the jumper, the contact element being disposed in the jumper insertion opening;
wherein the juniper insertion opening extends in the direction of insertion of the jumper into the jumper insertion opening from the housing base towards the housing upper surface at an angle α of between 20 and 70 degrees to a transverse axis of the housing.

2. The connection module according to claim 1, wherein the jumper insertion opening is disposed in an upper region of the transverse side of the housing, which region is disposed so as to be adjacent to the housing upper surface.

3. A connection module according to claim 1, wherein the jumper insertion opening is formed in a module insert, the module insert being inserted into an opening which is formed in the transverse side of the housing.

4. A connection module according to claim 1, wherein the jumper insertion opening is formed in a retaining element protruding from the transverse side of the housing.
